(19) United States
(12) Patent Application Publication
(10) Pub. No.: US 2024/0353554 A1
(43) Pub. Date: Oct. 24, 2024

(54) SINGLE RADAR STRIP CENTERING SYSTEM

(71) Applicant: LOGIKA SYSTEMS INC., St. Louis, MO (US)

(72) Inventors: Daniel Sego, St. Louis, MO (US); Paul Ream, St. Louis, MO (US)

(21) Appl. No.: 18/615,112

(22) Filed: Mar. 25, 2024

Related U.S. Application Data
(60) Provisional application No. 63/461,437, filed on Apr. 24, 2023.

(51) Int. Cl. G01S 13/72; G01S 7/02; G01S 7/40; G01S 7/41; G01S 13/88

(52) U.S. Cl. CPC G01S 13/72; G01S 7/027; G01S 7/4026; G01S 7/4056; G01S 7/415; G01S 13/88

(57) ABSTRACT

The present invention discloses a single radar strip centering system for measuring the position and width of a continuous metal strip during processing in order to adjust the position of the strip to meet or maintain centering. The single radar strip centering system includes a radar and a reflector positioned apart from one another. The reflector is provided with a spherical surface. The single radar strip centering system includes the strip placed in between the radar and the reflector. The strip includes a near wall and far wall. The strip includes a leading edge and trailing edge. The radar emits beams. The spherical surface on the reflector augments and shapes the scattered energy from the far wall. The radar simultaneously illuminates the leading edge and the reflector. The reflector redirects the transmitted energy toward the trailing edge and reflects radar energy scattered off the trailing edge back toward the radar.

### REFERENCE TO RELATED APPLICATIONS

The present application claims the benefit of U.S. Provisional Patent Application No. 63/461,437, filed Apr. 24, 2023; all of which is incorporated in its entirety herein and referenced thereto.

### FIELD OF THE INVENTION

The present invention generally relates to a field of measuring the position and width of a continuous metal (steel, aluminum, copper or other) strip. More particularly, the present invention relates to the process of measuring the position and width of a continuous metal strip during processing in order to adjust the position of the strip to meet or maintain some process requirement, such as centering. Relevant steel/metal processes include, but are not limited to, hot or cold rolling, galvanizing, annealing, or pickling.

### BACKGROUND OF THE INVENTION

It is known that several technologies are applied to determine the position of the edges of a strip under process, such as centering, for example. Some of the technologies to determine the position of the edges of the strip include the use of inductive sensors, camera or photoelectric sensors, and contact-mechanical systems employing strain gauges. In each of the above, two sensors are used; one for each edge of the strip. Each sensor makes a relative measurement of the position of the targeted edge and the measurements are placed in a common reference frame and are combined to generate an estimate of the strip current position/width. Position/width is transmitted to a centering control processor where an error correction is generated and sent to actuators to return the strip to a centered position.

Several apparatuses were disclosed in the past for measuring width, direction and position of a strip. An example is disclosed in a United States Publication No. 20130300598, entitled “Apparatus for measuring width direction end position of strip, apparatus for measuring width direction central position of strip and microwave scattering plate” (“the '598 Publication”). The '598 Publication discloses an apparatus for measuring width direction end position of a strip which passes through an enclosed space surrounded by a plurality of surfaces. The apparatus includes an antenna section which emits electromagnetic waves toward the width direction end and receives the electromagnetic waves reflected by the width direction end; a signal processing section for determining a position of the width direction end using the reflected electromagnetic waves; and a scattering plate for scattering electromagnetic waves which are incident thereon, wherein the antenna section is installed on a first surface which faces the width direction end a position of which is to be determined and the scattering plate is installed on a second surface which faces the first surface.

Another example is disclosed in a United States granted U.S. Pat. No. 7,659,729, entitled “Method and device for measuring width direction end position of stripe body, and method and device for measuring width direction center position of stripe body” (“the '729 patent”). The '729 patent discloses a microwave sending antenna and a microwave receiving antenna are provided to a right-side furnace wall, and the system is devised so that the microwaves emitted from the microwave sending antenna are reflected by the right-side edge of a cold-rolled steel plate, and the reflected waves are received by the microwave receiving antenna. Similarly, a microwave sending antenna and a microwave receiving antenna are provided to a left-side furnace wall, and the system is devised so that the microwaves emitted from the microwave sending antenna are reflected by the left-side edge of the cold-rolled steel plate, and the reflected waves are received by the microwave receiving antenna.

Yet another example is disclosed in a Chinese Patent Application No. 110308441, entitled “Steel strip position measuring sensor in annealing furnace” (“the '441 Publication”). The '441 Publication discloses a steel strip position measuring sensor in an annealing furnace. The measuring sensor comprises a casing, an antenna and an integrated device. The integrated device includes a signal measuring module for transmitting and receiving high frequency electromagnetic waves, a signal processing module for signal processing and a communication module for carrying out communication protocol processing. The signal measurement module is electrically connected to the antenna. According to the invention, a transmitting terminal of the measuring sensor transmits a radar signal electromagnetic wave; the radar signal electromagnetic wave is transmitted to the edge of a steel strip and a reflected echo is received by a receiving terminal of the measuring sensor; after processing by the integrated device, the position of the steel strip is measured without affecting the steel strip and devices in the furnace. Meanwhile, the measuring sensor can be mounted on the furnace wall directly by fixed screws; and when the antenna and electronic components on the measuring sensor need to be replaced, the measuring sensor can be directly removed for maintenance. And the measuring sensor is also suitable for split measurement with high applicability.

With the advent of recent technology, radar systems are used to perform the measurements. Radar systems offer several advantages over the traditional technologies. For instance, the radar is a noncontact measurement so the condition of the surface of the strip is not a factor. Further, the radar has longer operating wavelengths and therefore is less susceptible to airborne particulates occluding the line of sight. Furthermore, the radar equipment can be installed outside the working furnace or process section, realizing much more immunity from damage in the event of a catastrophic strip failure. Additionally, the installation of the radar outside the working furnace mitigates build-up of contaminants onto the sensors. Further, the range of edge positions i.e., strip displacement, and strip widths which can be measured is limited by the geometry of the millway not the measurement scheme.

The radar-based systems are used to determine the position of the edges of the strip using at least three ways. One, two radars are employed, each illuminating the nearer edge (as well as all other scatterers within the furnace segment and the sensors may have to be operated serially to avoid direct path receiver saturation, a secondary consideration). Second, a polarimetric radar is used to determine the target response or scattering matrix using two orthogonal polarizations. Here, if the strip thickness is less than a wavelength then aligning the antenna electric field (E field) with the plane of the strip results in the excitation of fringe currents on the upper and lower strip surfaces at the nearer (leading) edge. Rotating the polarization by 90 degrees (H plane parallel to the plane of the strip) excites fringe currents on the opposite (trailing) edge which are significantly weaker but which are detectable, particularly with additional integration. Thus, one radar with switchable polarization serial detection and ranging of both edges is possible. This phenomenology degrades as thickness exceeds a wavelength. Third, a single radar illuminating the wall opposite the radar will produce scattering in the direction of the far (trailing) edge and, because the path is reciprocal, scattered returns are directed to and received by the radar. The far wall is designed to be planar but process over time is expected to have physically distorted the shape and the resulting wall surface may be suboptimal to adequately illuminate the trailing edge.

Although the above discussed disclosures and radar apparatuses/systems are useful in determining the position of the edges of a strip, they have few problems. For example, the radar systems mostly employ radar sensors in pairs (two sources), one to each strip edge. The individual relative range measurements are, with knowledge of the furnace geometry, converted to an estimate of the strip position and/or width which is then transmitted to the centering system processors/actuators. Some waveform types (e.g., PN codes) are susceptible to self- or mutual interference and require either the addition of scattering or “splash” plates to diffuse the scattering from the opposite wall or interleaving of radar operation. Also, it is necessary to minimize the impact due to scatterers which are not of interest. This requirement is typically levied on the furnace as opposed to the sensing system; to present a nuisance scatterer-free region.

Therefore, there exists a need in the art to provide an improved single radar strip centering system for measuring the position and width of a continuous metal strip.

### SUMMARY OF THE INVENTION

It is one of the main objects of the present invention to provide a single radar strip centering system and that avoids the drawbacks of the prior art.

It is another object of the present invention to provide a single radar strip centering system for measuring the position and width of a continuous metal strip during processing in order to adjust the position of the strip to meet or maintain process requirements.

In order to overcome the limitations here stated, the present invention provides a single radar strip centering system for measuring the position and width of a continuous metal strip during processing in order to adjust the position of the strip to meet or maintain process requirements. The single radar strip centering system includes a radar and a shape tailored reflector positioned apart from one another. In one instance, the reflector is provided with a spherical surface (a spherical cap with open end facing the radar). The range of furnace geometries could require other shapes: cylindrical, planar, parabolic or some hybrid combination of such. Geometry is determined by the degree of bistatic scattering by the reflector over the range-of-regard of the trailing edge and over the span of strip widths and furnace positions.

The single radar strip centering system includes a strip placed in between the radar and the reflector. The furnace includes a near wall and a far wall. The wall closer to the radar (or onto which the radar is mounted) is referred to as the near wall and the wall closer to the reflector (or onto which the reflector is mounted) is referred to as the far wall. The strip includes a leading edge and a trailing edge. The leading edge indicates an edge closest to the radar. The trailing edge indicates an edge away from the radar i.e., the edge that is shadowed by the strip from the perspective of the radar.

In use, the radar emits beams in the form of frequency-modulated, continuous-wave (FMCW) waveforms or range strobes. For example, spherical surface on the reflector augments and shapes the scattered energy from the far wall. The radar simultaneously illuminates the leading edge and the reflector. The reflector redirects the transmitted energy toward the trailing edge and reflects radar energy scattered off the trailing edge back toward the radar.

In one advantageous feature of the present invention, the custom, passive retroreflector (reflector) is introduced and positioned to augment and shape the scattered energy from the far wall. The single radar simultaneously illuminates the leading edge and the reflector, the reflector redirects the transmitted energy toward the trailing edge and reflects radar energy scattered off the trailing edge back toward the radar receiver. When compared with known single radar systems, operating the radar inside furnace sections with the walls composed of steel panels, and including other scattering objects such as rollers, creates a challenging electromagnetic environment. The presence of conducting planar walls with the radar energy impinging at near normal incidence results in radar returns which are much, much larger than the strip edge returns. The above problem is solved by employing a large time-bandwidth waveform using the purpose-designed passive retroreflector (reflector) and tailored signal processing which exploits the static environment. The addition of a splash-plate would also serve to diffuse far wall scattering.

Features and advantages of the invention hereof will become more apparent in light of the following detailed description of selected embodiments, as illustrated in the accompanying FIGUREs. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates an electromagnetic diagram of single radar strip centering system, in accordance with one embodiment of the present invention;

FIG. 2A and FIG. 2B illustrate a top view and an end view, respectively of the single radar strip centering system, in accordance with one embodiment of the present invention;

FIG. 3A and FIG. 3B illustrate a side view and a top view, respectively of a spherical cap instantiation of the reflector, in accordance with one embodiment of the present invention;

FIG. 4 illustrates a representation diagram of a spherical reflector geometry, in accordance with one embodiment of the present invention;

FIG. 5 illustrates a graphical representation of bistatic RCS response with respect to the elevation angle mapped onto the trailing edge with reflector-to-edge range as a parameter, in accordance with a square planar (5A) and circular disk (5B) reflector embodiment of the present invention;

FIG. 6 and FIG. 7 illustrate a side view and a front view, respectively of an environment enclosure, in accordance with one embodiment of the present invention;

FIG. 8 illustrates a free-space test rig experimental setup showing the means by which data were collected for evaluation of signal processing algorithms, including the Orthogonal Projection (OP) algorithm, and basic sensitivity;

FIG. 9 illustrates a sample result comparing unweighted Fast Fourier Transform (FFT) to OP processed range compression, in accordance with one embodiment of the present invention;

FIG. 10 illustrates an exemplary application whereby a single radar solution is presented as applied to the measurement of sample thickness, in accordance with one embodiment of the present invention;

FIG. 11 illustrates a single radar edge detection and tracking system, in accordance with one embodiment of the present invention;

FIG. 12 illustrates an annealing furnace, in accordance with one embodiment of the present invention; and

FIG. 13 illustrates a block diagram of an edge detection and tracking system, in accordance with one embodiment of the present invention.

### DESCRIPTION OF THE EMBODIMENTS OF THE INVENTION

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed single radar strip centering system. However, it will be apparent to those skilled in the art that the presently disclosed invention may be practiced without these specific details. In some instances, well-known structures and devices are shown in functional or conceptual diagram form in order to avoid obscuring the concepts of the presently disclosed single radar strip centering system.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a single radar strip centering system, it is to be further understood that numerous changes may arise in the details of the embodiments of the single radar strip centering system. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present invention discloses a single radar strip centering system for measuring the position and width of a continuous metal strip during processing in order to adjust the position of the strip to meet or maintain centering. The single radar strip centering system includes a radar and a reflector positioned apart from one another. The reflector is provided with a spherical surface, oriented facing the radar. The single radar strip centering system includes the strip placed in between the radar and the reflector. The strip includes a leading edge and a trailing edge. The radar emits radio frequency energy, modulated into waveforms and collimated into beams. The radar simultaneously illuminates the leading edge and the reflector. The spherical surface of the reflector augments and shapes the incident energy, directing it onto the strip trailing edge, a bistatic geometry. The reflector redirects the transmitted energy toward the trailing edge and reflects radar energy scattered off the trailing edge back toward the radar.

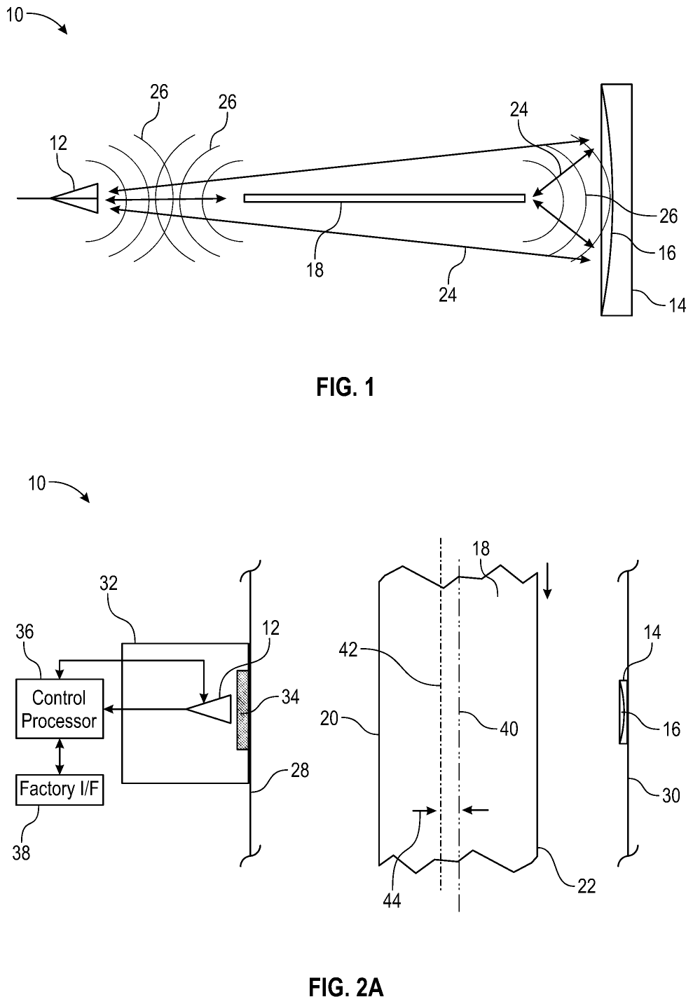

Various features and embodiments of a single radar strip centering system are explained in conjunction with the description of FIGS. 1-13.

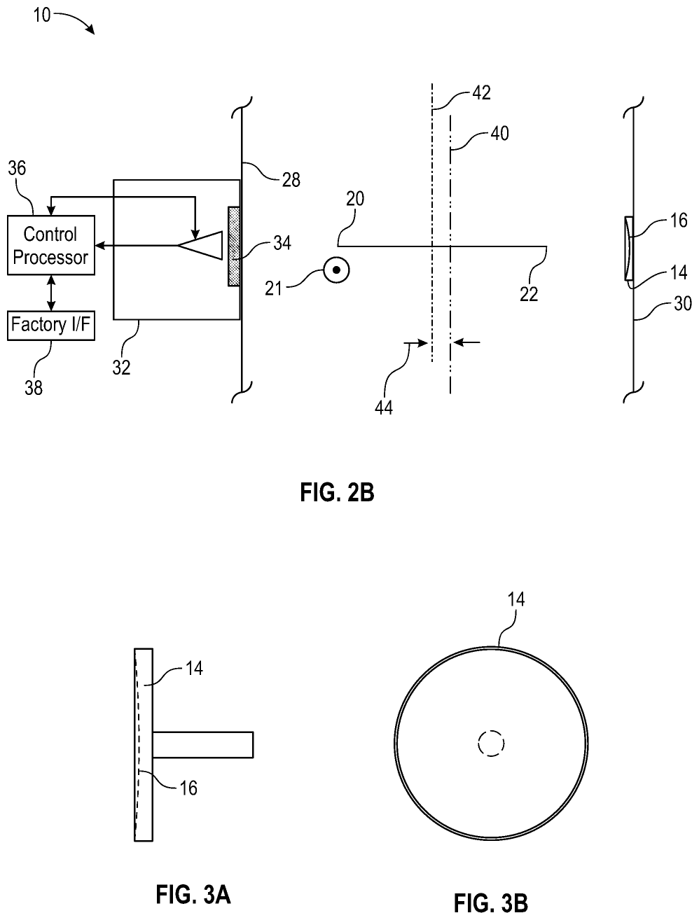

Referring to FIG. 1, an electromagnetic diagram of a single radar strip centering system 10 is shown, in accordance with one exemplary embodiment of the present invention. Further, FIG. 2A and FIG. 2B show a top view and an end view, respectively of single radar strip centering system 10, in accordance with one exemplary embodiment of the present invention. Single radar strip centering system 10 includes a radar 12. Further, single radar strip centering system 10 includes a reflector 14, in this example having a spherical reflecting surface 16. FIG. 3A and FIG. 3B show a side view and a front view, respectively of reflector 14, in accordance with one exemplary embodiment of the present invention. Here, reflector 14 is provided with a 1.2-meter (m) radius of curvature machined specific to a 2.4 m millway (spherical surface 16, near wall-far wall separation 28 and 30). In the present invention, single radar strip centering system 10 includes a strip 18. Strip 18 includes a continuous metal (steel, aluminium or other) strip. Strip 18 includes a leading edge 20 and a trailing edge 22. Further, strip 18 presents a continuous strip motion 21 out of plane. Here, leading edge 20 indicates an edge closest to radar 12. Trailing edge 22 indicates an edge away from radar 12 and/or and the edge that is shadowed by strip 18 from the perspective of radar 12. Radar 12 emits/transmits radar beams 24 in the form of frequency-modulated, continuous-wave (FMCW) waveforms or range strobes 26.

As can be seen from at least FIG. 2A and FIG. 2B, radar 12 and reflector 14 are aligned facing each other, on each side of the millway section in which the centering measurement is to be made. In the present invention, the wall closer to radar 12 is termed a near wall 28 and the wall closer to reflector 14 is termed as a far wall 30 (or the reflector wall). Here, reflector 14 and radar 12 are aligned such that the radar antenna boresight vector is coincident with, and anti-parallel to, the axis of symmetry of the reflector surface (a common axis). Furthermore, the positioning of reflector 14 is such that the center point on the reflector surface (that point where the axis of symmetry of reflector 14 intersects the reflector surface) is at the same distance from the antenna as the far wall normal point, with respect to the antenna boresight, would be if the reflector were absent. In this manner, the reflector returns and any far wall returns are coincident in radar range.

In the present embodiment, radar 12 is positioned within an enclosure 32. Radar 12 includes a Radio Frequency (RF) transparent refractory blanket 34 (which may include a radome). Radar 12 communicatively connects to a controller/control/processor (or control processor) 36. Control processor 36 performs signal and data processing of the radar returns and is connected to the factory infrastructure, which includes the centering actuator controller, via factory interface (I/F) 38.

Radar 12, within enclosure 32, is positioned outside of a furnace (not shown) or process section. Strip 18 has a strip geometric center 40, which is different from a furnace geometric center 42 (i.e., center axis of furnace). The difference in strip geometric center 40 and furnace geometric center 42 is referred to as centering offset 44.

In the present embodiment, the shape of the reflector surface (reflector 14) is optimized based on the size (width) of the millway section, the range of possible positions that strip 18 occupies due to misalignment to the millway geometric center, and the range of strip widths which the mill processes. For example, the millway width is provided as 2.4 meter (m) and it is assumed that the mill processes strip 18 from 0.3 m (1 feet (ft)) to 1.8 m (6 ft). In one experimental set up, a spherical reflecting surface with a radius of curvature of 1.2 m is considered. Here, the reflector diameter of 192 mm (0.192 m) and, with the 1.2 m radius of curvature, results in a depth of 3 mm. This design yields the required probability of detection over the nominal range of edge positions based on the thinnest strip (0.1 mm), with the smallest width (0.3 m) with strip edge position no closer than 200 mm (0.2 m) from either wall. The scattering response of reflector 14 is a function of range from reflector 14. This is due to range curvature and the location of the edges in the near field of the reflector (incident wave fronts are not plane waves). More defocusing is experienced at short ranges where space-loss is decreased and a broader “beam” illuminates a larger edge angular segment defined by the bandwidth/range resolution of the waveform. As range increases the collimation of the scattered pattern approaches maximum, presenting larger RCS to counteract the increased space-loss (i.e., R-squared, one way).

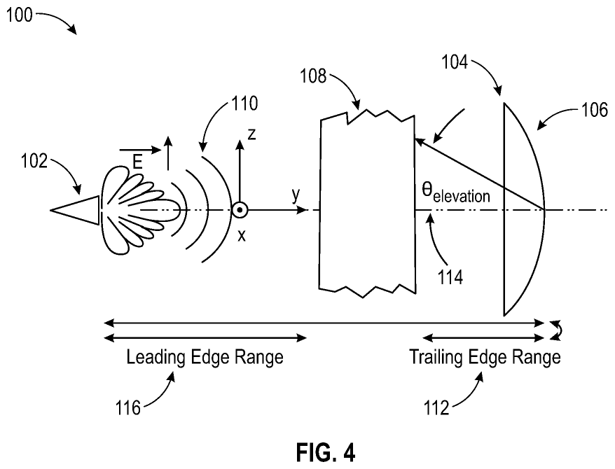

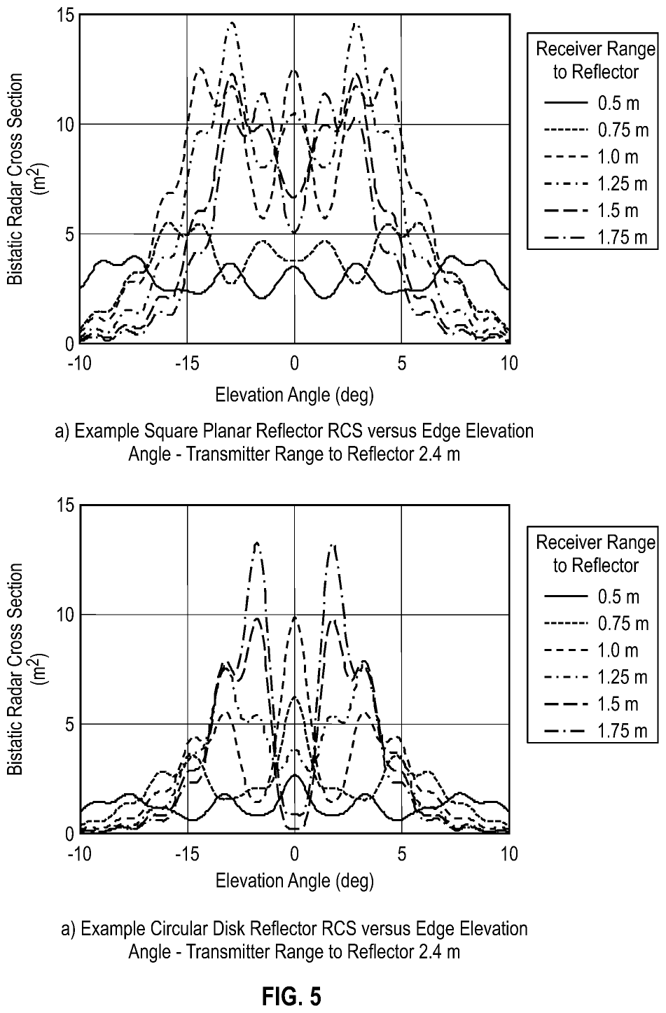

In one embodiment, radar 12 is positioned relative to strip 18 and/or reflector 14. FIG. 4 shows a representation diagram 100 of spherical reflector geometry, in accordance with one embodiment of the present invention. As can be seen, a radar 102 aligns with a reflector 104 having a spherical surface 106. Here, a strip 108 is positioned vertically with respect to radar 102 and reflector 104. Radar 102 emits continuous-wave (FMCW) waveforms or range strobes 110 in the direction of strip 108. The total distance between the point at which spherical surface 106 meets the center axis of the reflector and the edge (vertical trailing edge) of strip 108 is termed as trailing edge range 112. Further, the angle at which the FMCW waveform deflects is considered as an elevation angle 114. FIG. 5 shows graphical representations 200 of RCS response with respect to the elevation angle mapped onto the trailing edge for two examples of reflector surface: square flat plate and circular disk.

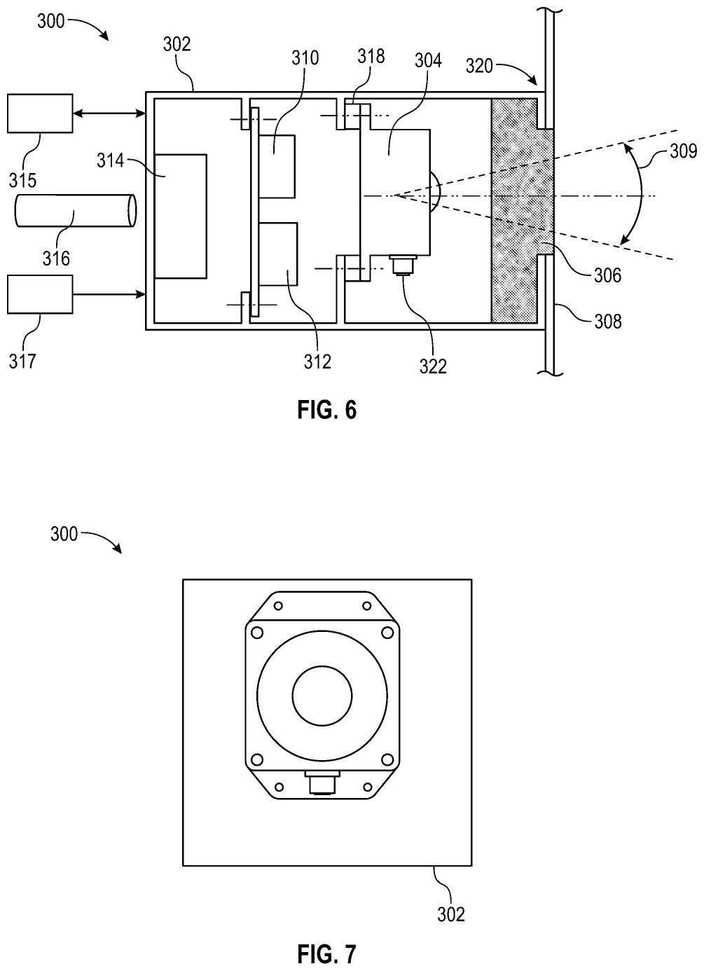

Now referring to FIG. 6 and FIG. 7, a side view and a front view, respectively of an environment enclosure 300 are shown, in accordance with one embodiment of the present invention. In FIG. 7, the millway opening cover blank is removed in the front view (and only partially shown in the side view). Enclosure 300 is similar to enclosure 32, shown in FIG. 2A above. FIG. 6 presents a design for enclosure 300, which ensures the interior temperature is in the nominal range +5 to +50 C and which provides isolation from shock and vibration conducted through the coupling to the furnace/millway wall(s). Enclosure 300 includes a chassis 302 encompassing a radar 304 (similar to radar 12). Chassis 302 is designed to maintain the conditions inside chassis 302 compatible with the requirements of the electronics contained therein (such as temperature, humidity, shock and vibration). Enclosure 300 presents an open aperture and millway wall for radar 304 to illuminate the interior of the millway through any refractory or radome materials. In other words, chassis 302 includes a refractory blanket 306 at the aperture. Here, the opening is filled with refractory blanket 306 that thermally isolates enclosure 300 from the millway and which is RF transparent (or with very low insertion loss). Optionally, the opening is filled with quarter-wavelength quartz or similar “radome” to prevent particulates from being deposited on refractory blanket 306. Alternatively, enclosure 300 may be over pressured by a cooling system (not shown) to prevent particulates from being deposited on refractory blanket 306, or the window design may incorporate pressurized airflow to keep the window particulate-free.

In FIG. 6, refractory blanket 306 having millway side opening blank partially is shown. As can be seen, radar 302 is placed behind refractory blanket 306 in close proximity. Chassis 302 presents a near wall 308. Here, near wall 308 (similar to near wall 28, shown in FIG. 2B) indicates a wall closer to radar 304. In other words, chassis 302 is mounted to near wall 308, and external to (outside) the millway. Chassis 302 includes a USB extender 310 and a power supply 312 for powering radar 304 and other enclosure electronics from factory prime power 317. Extender 310 and power supply 312 are both positioned behind radar 304. Enclosure 302 includes a pressure regulator 314. Pressure regulator 314 steps down factory air received from a container 316 as per the design rating of enclosure 302. Chassis 302 presents shock/vibration isolation area 318 between chassis 302, and radar 304, refractory blanket 306, USB extender 310, power supply 312 and pressure regulator 314. Further, chassis 302 presents a thermal isolation area 320 at the intersection of enclosure 302 and near wall 308. In one implementation, radar 304 calls out for a conditioned power 322.

In the present invention, radar 302 is positioned such that radar 302 is recessed 1-2 inches (25.4-50.8 mm) from the inner surface of refractory blanket 306. Combining the nominal refractory blanket 306 thickness with the antenna offset yields R_{wall_offset}, the net range offset of the radar chassis relative to the near wall inner surface. This recess distance is measured from the outer surface of the radar chassis 302 front face which is coincident with the base of the quasi-spherical dielectric lens forming the front surface of the radar chassis. The plane of the chassis 302 front face serves as the physical reference for the measurement geometry. As the range reference point (zero range) is the IF mixer mounted on a board inside the radar chassis (a distance in space) 302, connected to the radar feed antennas (one transmits, the other receives) via stripline waveguide (or similar) with group velocity less than free space (an additional propagation delay), there is a range offset from the range reference to chassis front face (R_{face_offset}). Edge range (not shown, similar to edge range 112 and 116 in FIG. 4) is measured relative to the radar range reference point then shifted to a geometric reference coplanar with the inner surface of the near wall.

In use, control processor 36 provides control, timing and processing to and with radar 304 as well as serving as the interface to the factory infrastructure. The interface to the factory infrastructure includes factory control and monitoring systems and the transmitting processed estimates of the deviation of the strip geometric center from the factory designated position within the millway (for example the millway geometric center) to the centering control system and associated actuator(s). Control processor 36 may be co-located with the radar, installed at some distance from the environmental enclosure 300, or in its own enclosure but at a more benign location. Enclosure 300 operates from factory power 312 and accepts factory air 316 as an input for the cooling function.

Now referring to FIG. 1, the principle of operation of single radar strip centering system 10 is explained. Radar 12 emits the FMCW waveform 26. FMCW waveform 26 propagates outward as a spherical wavefront. Some portion of the FMCW waveform 26 energy is reflected back toward radar 12 after scattering off leading edge 20 (located at range R_{LE}), which may be in the near field of the transmit antenna. The outgoing spherical wavefront propagates past strip 18, a portion diffracting around strip trailing edge 22, and impinges on far wall 30/reflector 14. A portion of the energy is then reflected (and focused by reflector 14) in the direction of trailing edge 22 (located at range R_{TE}), which is the near field of reflector 14. Some fraction of the energy illuminating trailing edge 22 is reflected back toward the spherical reflector 14, a portion of which is reflected back toward the radar antenna 12. The radar signal continues to reflect back-and-forth, from wall-to-wall. The once-around return (from near wall 28 off far wall 30) is observed. This geometry is directly analogous to the double-bounce multipath effect experienced by airborne, air search radars. The trailing edge signal-to-noise ratio reflects the multi-bounce operation, based on an equation given below.

$$\frac{S}{N} = \frac{{P}_{ave} {G}_{t} {G}_{r} {λ}^{2}}{{( 4 π )}^{2} {L}_{system} {k}_{B} {T}_{0} {F}_{n} {B}_{n} {R}_{Wall}^{4} {R}_{TE}^{4}} {σ}_{refl}^{2} {σ}_{TE}$$

In the above equation, Pₐᵥₑ is the radiated average power (W), Gₜ and Gᵣ are the transmit and receive gains (respectively, dimensionless) which for either may be in the near field (plus range curvature) and are thus functions of range. σ_{refl} is the scattering cross section of the reflector (m²) and σ_{TE} the RCS of the trailing edge (also m²), and λ is the wavelength (m). All systematic losses are lumped into L_{system}, k_{B} is Boltzmann's constant, T₀ is the reference temperature (290 K), Fₙ the noise figure, and Bₙ the noise bandwidth (1/T_{chirp}). In codifying leading edge 20 return signal-to-noise (SNR), the above equation is used with OLE replacing σ_{TE}, R_{TE} is replaced by R_{LE} and R_{Wall} and σ_{refl} dropped, and the exponent on (4π)⁵ replaced with 3 ((4π)³) resulting the standard radar range equation.

After powering up radar 12 and operating state are initialized, radar 12 is configured with parameters uploaded from control processor 32. The operation begins with control processor 32 commanding an FM ramp of bandwidth B_{chirp} to be radiated over the interval T_{chirp}. Here, the direction of the frequency ramp (up or down) is not relevant. Radar 12 employs simultaneous transmit-while-receive (a transceiver, not shown). Radar 12 receives RF energy is mixed against the transmitted signal in a homodyne receiver to yield a sinusoidal time series with frequency a function of scatterer range, quantities which are related through the chirp constant k_{chirp} (B_{chirp}/T_{chirp}), as given in the equation below.

$${τ}_{delay} = \frac{2 R}{c} and f = {τ}_{delay} {k}_{chirp}$$

The time series is digitally sampled after any analog filtering and quadrature demodulation, after which control processor 36 instructs radar 12 to download the discrete time series to control processor 36. After download, there are a series of conditioning operations performed: DC bias and channel gain mismatch are corrected and the time series is bandlimited and decimated (reducing the sampled time series from 2048 complex values to 512). This process reduces the maximum range supported to something on the order of twice the furnace width. Decimation then reduces the number of samples in the time series without introducing aliasing. Reducing time series length reduces the computational load.

Further, the complex time series is compressed, using the Fourier Transform which converts frequency (f) to range (R). A windowing function may be applied prior to performing the transform to suppress range sidelobes. After converting the complex voltage to power, detection is performed over the range-of-regard (RoR); that region of the range domain corresponding to the positions the edges may physically occupy. Range estimates are made for each detection. A track is initiated on the leading edge (trivially detected because of the proximity to the radar) and on trailing edge 22 to the degree supported by sensitivity (as impacted by wall/reflector range sidelobes). Nominal width is an input from the factory control system used to coach the regions for detection, reducing the range-of-regard (RoR).

In one example, the initial twenty-five strobes define the weight initialization period. In parallel to pulse compression using the weighted FFT (discrete or fast Fourier transform), radar 12 is simultaneously generating a covariance matrix using the Sample Matrix Inversion (SMI) algorithm as shown below.

$${R}_{c} = \frac{1}{N} {\sum }_{i = 0}^{N - 1} {x}_{i} {x}_{i}^{H}$$

In the above equation, x represents a complex row vector, the subscript H indicates the complex conjugate transpose operation and N is the number of sample vectors averaged. R_{c} is an Nₛₐₘₚₗₑ by Nₛₐₘₚₗₑ complex matrix. Generating the covariance matrix cannot include target data so the input time series is converted to the frequency domain and the (complex) voltage value in the series of filters corresponding to possible edge positions are either set to zero or replaced by artificially generated noise based on noise statistics derived from the measurement, then inverse transformed to the time domain. Large, stationary scatterers are included in the time series but smaller edge returns are eliminated. This is done because of the static nature of the geometry and the physical bound on possible edge positions (known a priori). Again, leading edge measured range and nominal width may (likely will) be used to minimize the number of filters requiring intervention on both leading and trailing sides of the reflector.

The covariance matrix (R_{c}) then undergoes eigen-decomposition, generating an eigenspectrum of eigenvalues (ordered in decreasing magnitude). The dominant eigenvalues define the interference subspace while the lesser eigenvalues define the noise subspace. Employing a technique called Orthogonal Projection, weights for each range bin are computed using a steering vector to the range bin/filter under test. For range filter/bin fltr the normalized steering vector is used as shown in the equation below.

$${s}_{k} = \frac{1}{n} {e}^{j 2 π \frac{k}{{N}_{samples}} \frac{fltr}{m}}$$

In the above equation, k=0, . . . , Nₛₐₘₚₗₑₛ−1 and fltr=0 . . . . N_{fltr} and m is the oversample factor. The interference subspace eigenvalues (σ) and eigenvectors (U) are used with the steering vector to generate the weight vector for range bin fltr as given by the equation shown below.

$$w = s - {\sum }_{ik = 0}^{{N}_{eigs} - 1} [ ( \frac{{λ}_{ik} - {λ}_{min}}{{λ}_{ik}} ) ( ( {U}_{ik}^{H} s ) {U}_{ik} ) ] .$$

In the above equation, Uᵢₖ indicates the ik^{th} column of the eigenvector matrix, a Nₛₐₘₚₗₑ×Nₛₐₘₚₗₑ matrix or Nₛₐₘₚₗₑ eigenvectors ordered to match the eigenvalue vector. The weight vector is of length Nₛₐₘₚₗₑ. Each signal subspace eigenvector is a steering vector to an interference source in frequency/range. The orthogonal projection weight vector is designed to be orthogonal to the interference subspace, cancelling those contributions. The compressed range bin complex result is given by the inner product using the equation given below.

$${Rbin}_{fltr} = wx$$

In the above equation, x is the length Nₛₐₘₚₗₑ bandlimited and decimated time series vector

$${R}_{c} = \frac{1}{N} {\sum }_{i = 0}^{N - 1} {x}_{i} {x}_{i}^{H}$$

and the weight vector is from the equation

$$w = s - {\sum }_{ik = 0}^{{N}_{eigs} - 1} [ ( \frac{{λ}_{ik} - {λ}_{min}}{{λ}_{ik}} ) ( ( {U}_{ik}^{H} s ) {U}_{ik} ) ] ..$$

This process resembles the Discrete Fourier Transform in that each digital range frequency to be processed is explicitly defined and only those defined are processed.

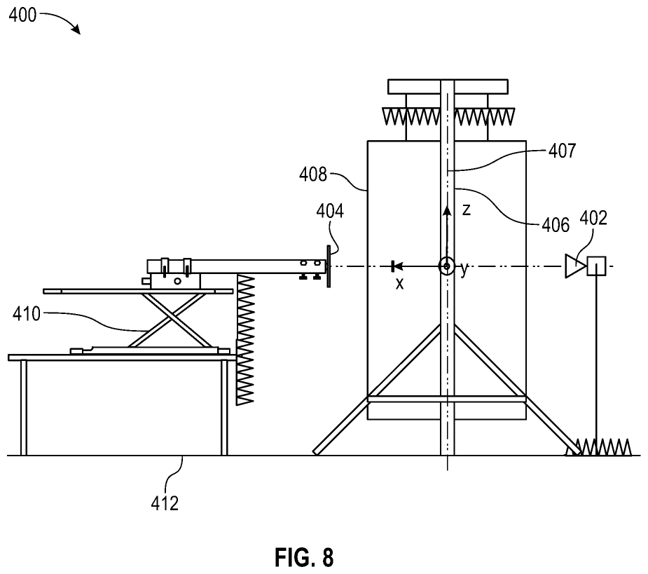

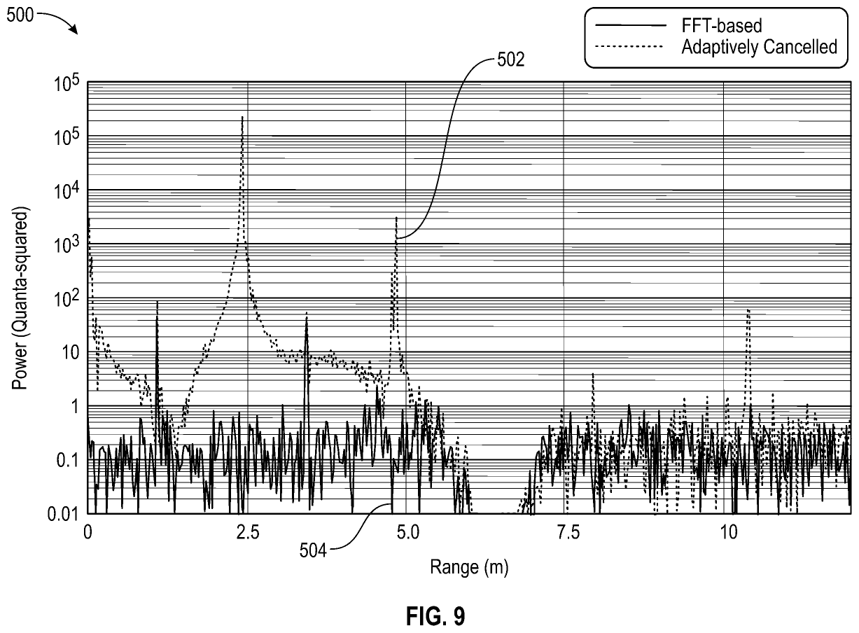

FIG. 8 shows a free-space test rig experimental setup 400 illustrating the laboratory configuration to collect radar data to demonstrate the performance of the Orthogonal Projection (OP) algorithm to cancel the nuisance scatterers, in accordance with one exemplary embodiment of the present invention. The setup 400 shows a radar 402 and a reflector 404 having a spherical reflecting surface. Here, a strip 408 is suspended in the free-space test fixture with a sensor head 402 oriented toward the leading edge. The early range leakage, reflector and single bounce return off the sensor mast represent the dominant undesirable signals. FIG. 9 shows a graphical representation 500 of the measured data using metal strip samples suspended in the free-space radar cross section fixture depicted in FIG. 8. In other words, FIG. 9 shows a sample result comparing unweighted (Fast Fourier Transform) FFT to OP processed range compression. In the graphical representation 500, numeral 502 represents FFT-only processing, and numeral 504 represents the performance after OP cancellation. FIG. 9 shows the near ideal removal of the three dominant returns: short range transmit leakage, the far wall/reflector return and the near wall (once-around) return. Results are obtained without loss of range resolution associated with application of window functions for sidelobe control.

Following Orthogonal Projection, square law detection is performed on the power detected Rbinₖ (=|Rbinₖ|²), using a Constant False Alarm Rate (CFAR) algorithm and contiguous detections are appropriately grouped. Range is estimated using a centroid algorithm and detected objects (estimated range and peak amplitude) are sent to a track processor. In a parallel stream the quality of the covariance matrix is tested with the most recent measurement. If the test passes the data vector (x) is placed in a Nₛₐₘₚₗₑ row by 25 column matrix, replacing the oldest entry. If the quality test fails then this matrix, with the 25 most recent measurement vectors, is used to generate a new covariance matrix to be applied to the next observation.

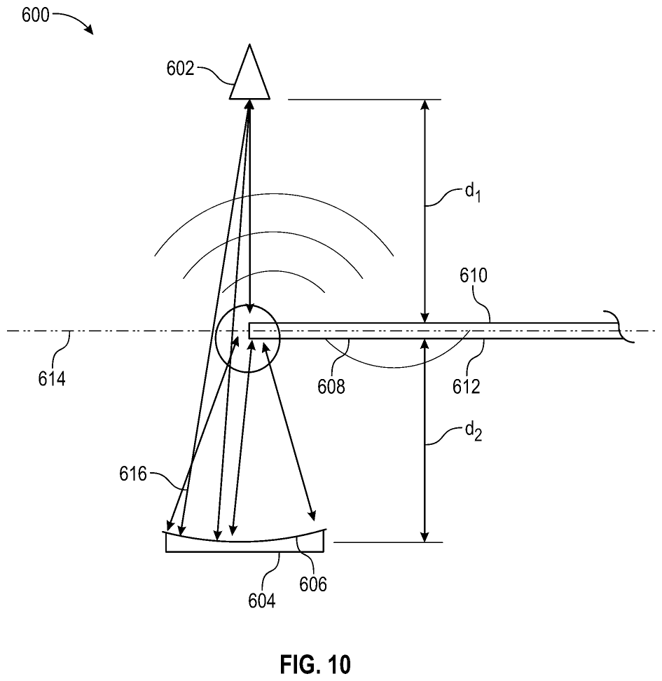

FIG. 10 shows an exemplary application 600 whereby the single radar solution is presented as applied to the measurement of sample thickness. Here, a radar 602 positions apart from a reflector 604 having a parabolic surface 606. Radar 602 and reflector 604 are positioned on a common axis. Here, a strip 608 is positioned intentionally to occlude one-half of the illuminating radar beam 616. Strip 608 positions at a first distance d₁ from radar 602. Further, strip 608 positions at a second distance d₂ from reflector 604. Strip 610 includes a top surface 610, a bottom surface 612, and a center plane 614. The parabolic reflector 604 is positioned such that the incident total field (incident plus diffracted) is reflected and collimated at bottom surface 612. Here, strip 608 is effectively infinite due its length and width extending well outside the illuminating main beam.

As strip 608 is positioned to occlude, for example, one half of the illuminating beam, this causes reflector 604 to be illuminated by the total field (one half of the incident field plus the diffracted field). This illumination results in a reflected pattern formed by the parabolic reflector 604 (here a parabolic is applied to focus the energy to a smaller spot as the range to the bottom edge is essentially fixed). Path lengths are the same to the bottom surface 612 after scattering. Two range estimates are made, filtered, and the range difference becomes the thickness estimate.

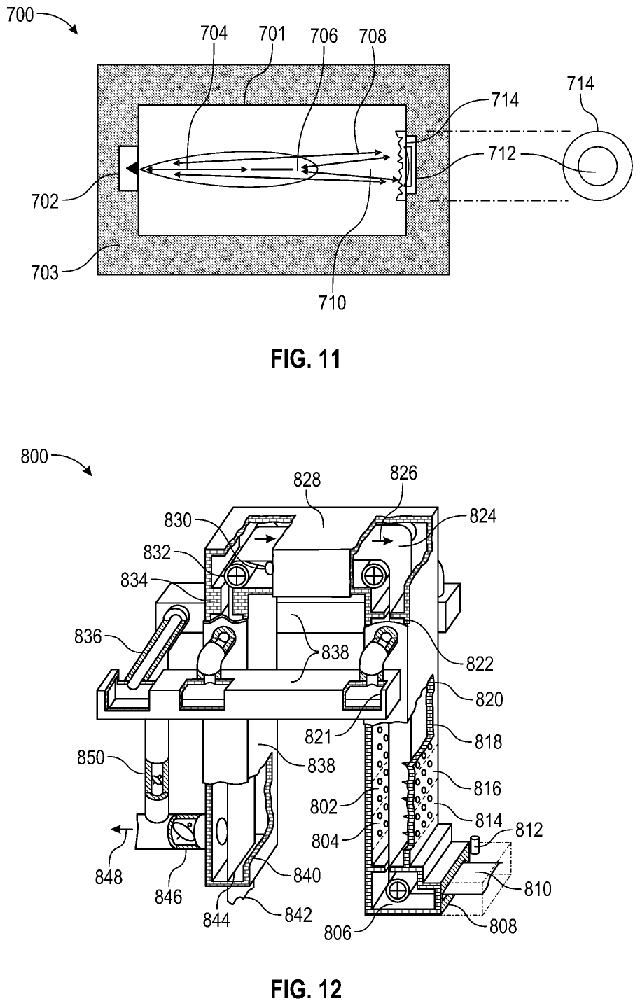

FIG. 11 shows a cross section of a millway 700 i.e., a cross-section of a furnace presenting a view along a strip of single radar edge detection and tracking system. A leading (left) edge 702 of a (steel) strip 701 in a refractory lining 703 is directly illuminated by a radar (R1) 704 while a trailing edge 706 is illuminated by the focused radar energy scattering off a spherical reflector 712, then returning to the radar antenna on the reciprocal path (paths R2a 708 and R2b 710). In the present embodiment, a filtering approach cancels the return from reflector 712 (and the far wall), allowing detection of the trailing edge returns even while in relatively close proximity with reflector 712. Further, a diffusor plate 716 is incorporated, which is mounted with and around reflector 712.

The diffusor plate 716 can be designed to scatter in random directions (random surface) or in deterministic directions (ramped planar surface), and is applied at need and as dictated by the overall millway geometry and nuisance scatterer mitigation requirements: converting strong specular scatter from the wall opposite radar 704 (and multiple-bounce specular returns in the enclosed environment) and back at radar 704, into a lower power, spatially dispersed return. The present embodiment only employs a single radar to range both edges simultaneously; while meeting millimetre-level measurement accuracy requirements. The core of the solution is a low power, wide bandwidth, frequency modulated continuous wave (FMCW) radar system which is produced by IMST™ in Germany, operating in conjunction with a specially designed retroreflector 712.

Continuous strip 701 passes in front of the radar (and between radar 704 and reflector 712). Radar 704 emits 2 msec duration frequency modulated “chirps” with a modulation bandwidth of 6 GHz (Table 1). Strip leading edge 702 is directly illuminated and scatters back to the antenna (in typical monostatic fashion and illustrated by path R1). Transmit energy illuminates the reflector (path R2a) which reflects energy to illuminate the trailing edge 706 of the strip (path R2b). Energy scatters off the trailing edge 706 and back to radar 704 via the reciprocal path. In radar 704, the received frequency ramp is mixed with the outgoing pulse to create a signal wherein range is encoded as frequency (the basic principle of FMCW operation). An orthogonal projection is employed to remove the return from reflector 712. This process converts the time domain signal to a range strobe (received power vs range). Removing the very bright reflector signal prevents the range sidelobes of reflector 712 from masking the trailing edge signal which is at a longer range but in proximity to the reflector. Leading edge 702 and trailing edge 706 may be detected using a non-adaptive threshold (because of the static/slowly) changing (thermal) geometry of the millway. The range bins on either side of the detected bins (number and rough location of which are known prior) are extracted and the fine range estimated. Range is translated into mill geometry/coordinates and the strip center location calculated.

The width of the millway and the range of strip widths processed contribute to the shaping of reflector 712, which may or may not be in the far field of the illuminating radar 704. On the return scattered path, the receiver is certainly in the near field of reflector 712. Wide strips will place the trailing edge 706 close to reflector 712 while narrow strips will have longer ranges (trailing edges are in the near field of the reflector). Reflector shape trades have led to the selection of a spherical surface to provide the illumination/gain over the range of regard that the trailing edge could occupy, yielding detectable signal levels. The radius of curvature is a function of the width of the millway. For example, a 2.4 m wide channel the optimum radius of curvature for strips from 30 cm to 200 cm is 1.2 m.

The main beam illuminating spot on the far wall is larger, as determined by the 3 dB beamwidth, than reflector 712. To combat specular scattering from the far wall, due to this over-illumination, which is likely more problematic when the walls are metal versus refractive brick, a plate with a randomized or faceted surface is positioned around the reflector. This randomized scatter reduces multi-bounce wall clutter which occurs in the range window with the trailing edge return.

Radar system 700 presented in FIG. 11 operates as a continuous wave (CW, unmodulated) radar in Doppler mode or as a FMCW radar in ranging mode. Select parameters of the radar system are listed in Table 1.

TABLE 1
DK-sR-12LRi Parameters

| Parameter | Value | | Parameter | Value |
|---|---|---|---|---|
| EIRP (patch | −15 dBm-13 dBm | | Antenna type | Chip Integrated Patch |
| radiator) | (8 steps) | | | antennas |
| EIRP (dielectric | −3 dBm-25 dBm | | Beamwidth (BW) | 65o Az. × 60o El. |
| lens) | (8 steps) | | | |
| Operating | 57-64 | GHz | BW (w/dielectric | 7o Az. × 8o El. |
| Frequency | | | lens) | |
| FMCW Ramp | 0.002-2 | s | Polarization | Linear |

| | | | |
|---|---|---|---|
| duration | | | |
| Waveforms | LFM (upchirp, | Range Supported | 0-50 m @ 6 GHz BW |
| | downchirp), CW | | |
| Operating power | 2 W (1.2 W standby) | Range res. (6 GHz | 25 mm |
| | | BW) | |
| Sensitivity | 28 m for 8 dBsm | Sensitivity | 40 m for 18 dBsm |
| (detection range) | RCS (with dielectric | (detection range) | RCS (with dielectric |
| | lens) | | lens) |
| Operating | −40° C.-600° C. | Chassis/housing | 110 mm × 84 mm × 52 mm |
| temperature | | | |
| Weight | 200 g (without | Protection code | IP 65 |
| | cabling) | | |

The radar is essentially a two-chip architecture; an analog chip which generates the coherent, stable RF signal (with modulation) and which performs the RF to baseband mixing, filtering and digital sampling operations. The second chip is the processor.

FIG. 12 shows an exemplary representative annealing furnace 800, in accordance with the present invention. Annealing furnace 800 includes a wall 802, housing a burner 804 having a transition zone at the bottom 806. Annealing furnace 800 includes a first air lock 808 for holding a hot strip 810. Further, annealing furnace 800 includes a first pyrometer 812. Burner 804 includes hot zones HZ A 814, HZ B 816, HZ C 816 and HZ D 818. Further, annealing furnace 800 includes a second airlock 824. At the top i.e., transition zone top 828, strip 824 being rolled 826 from a strip roll 832 is shown. Further, annealing furnace 800 includes a second pyrometer 830. Annealing furnace 800 includes a contraction, a bypass 836, PCC 838 and PH 839. Gas flow direction is indicated by numeral 840. A third air lock 844 holds cold strip 842. Further, annealing furnace 800 includes a first flap valve 846, a funnel 848 and a second flap valve 850.

As known, production of steel strip (continuous sheets of fixed width and thickness), hot or cold rolled, and processed strip, is a highly automated process and represents a very large market. Much of steel processing is a roll-to-roll (a subset of the larger field termed “web processing”) wherein the untreated/processed steel is unwound from a coil, processed in some manner, and the finished product rewound to a finished coil. While processing the continuous strip, where the strip passes over many change-of-direction rollers 832 as shown in FIG. 12, which is designed to compress the physical length of the furnace or mill, it is necessary that the position of strip 832 within the furnace or mill be managed so that physical tolerances are met, that treatment processes (e.g., pickling, galvanizing, or annealing) are evenly applied and so that the final coil wind meets uniformity constraints. This is accomplished by a combination of sensors which measure the position of the strip edges and actuators which shift the position of the strip. In one example, five to six instrumented locations can be provided within a single millway.

The presently available radar-based systems operate in the presence of dust, steam, haze, etc. and make radar attractive relative to passive optical and laser solutions. The available systems employ one transmit and one receive antenna pair located on each side of the steel trip to detect and estimate the range (from 0.2 m to ˜1.2 m) of the closest edge. Antennas are external to the millway, removing hardware which might be damaged with a strip rupture. Antennas may be designed to operate at high temperatures (˜1000 C) or can be placed behind radio frequency transparent refractory blankets to operate at factory temperatures.

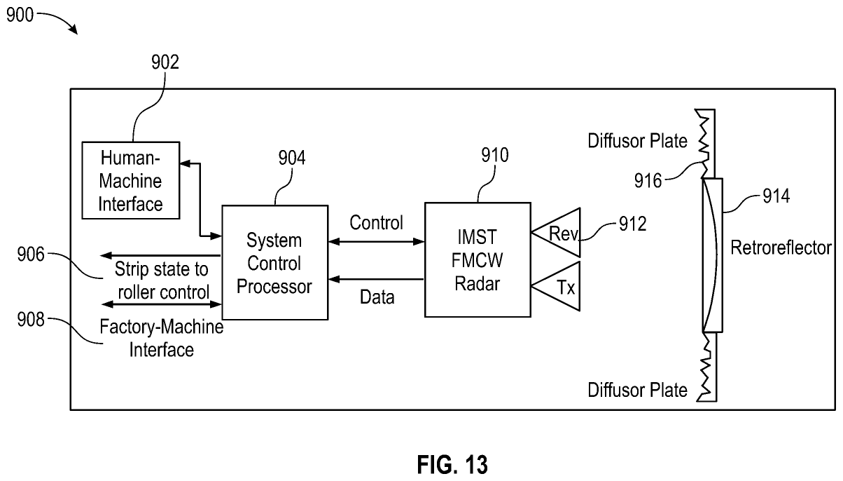

FIG. 13 shows a block diagram of an edge detection and tracking system 900, in accordance with one exemplary embodiment of the present invention. Edge detection and tracking system 900 presents a human-machine interface 902, a factory-machine interface 908 and a strip state to roller control 906 interfacing and interacting with a system control processor 904. System control processor 904 connects to a radar 910 and a receiver 912. Further, edge detection and tracking system 900 includes a reflector 914 and a diffusor plate 916. In the present embodiment, edge detection and tracking system 900 offers simultaneous detection of both strip edges of a strip undergoing processing while using only a single, off-the-shelf, radar system. In one example, edge detection and tracking system 900 employs polarization diversity to excite the fringe currents on each edge from a single sensor position: polarization parallel to the strip plane exciting the leading or nearer-edge fringe currents and perpendicular to plane of the strip to excite the far or trailing edge currents. In another example, edge detection and tracking system 900 employs a multipath approach, wherein a specialized reflector such as reflector 914 directs energy from the transmit antenna to illuminate the trailing edge which reflects back to radar 910 via the reciprocal path. It is preferable to employ the multipath approach as the cost to modify existing radar for switchable linear polarization is excessive, or two distinct radars are required, and for sensitivity considerations, again relative to our desire to utilize an off-the-shelf radar.

The presently disclosed single radar strip centering system provides several advantages over known art. For instance, the passive retroreflector (reflector) is introduced and positioned to augment and shape the scattered energy from the far wall. The single radar simultaneously illuminates the leading edge and the reflector. Further, the reflector redirects the transmitted energy toward the trailing edge and reflects radar energy scattered off the trailing edge back toward the radar receiver.

The presently disclosed single radar strip centering system can be used to adjust the position of the strip to meet or maintain some process requirement, typically centering. A person skilled in the art appreciates that the single radar strip centering system can come in a variety of shapes and sizes depending on the need and comfort of the user. Further, many changes in the design and placement of components may take place without deviating from the scope of the presently disclosed single radar strip centering system.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A single radar strip centering system for measuring the position and width of a continuous metal strip during processing to facilitate adjustment of the strip's position for centering, said single radar strip centering system comprising:
a radar configured to emit beams;
a reflector positioned apart and facing said radar; and
a continuous metal strip positioned between said radar and said reflector, wherein said strip comprises a leading edge and a trailing edge, wherein said leading edge indicates an edge closer to said radar, and wherein said trailing edge indicates an edge away from said radar,
wherein said radar simultaneously illuminates said leading edge of the strip and said reflector,
wherein said reflector augments and shapes scattered energy, and
wherein said reflector redirects transmitted radar energy toward said trailing edge and reflects radar energy scattered off said trailing edge back toward said radar via a reciprocal path.

2. The single radar strip centering system of claim 1, wherein said reflector comprises a spherical surface.

3. The single radar strip centering system of claim 1, wherein said single radar strip centering system implements in a furnace having a near wall and a far wall, wherein said near wall indicates a wall on the side of said radar, and wherein said far wall indicates a wall on the side of said reflector.

4. The single radar strip centering system of claim 2, wherein said far wall is planar and impinges the radar energy at near normal incidence.

5. The single radar strip centering system of claim 3, wherein said radar and said reflector are aligned such that an antenna boresight vector of said radar is coincident with, and anti-parallel to, the axis of symmetry of the surface of said reflector.

6. The single radar strip centering system of claim 5, wherein positioning of said reflector is such that a center point of the surface of said reflector is at the same distance from the antenna boresight vector as said far wall.

7. The single radar strip centering system of claim 1, further comprises a diffusor plate for reducing the returning radar energy scattered off from said reflector and supporting detection of the radar energy at said trailing edge.

8. The single radar strip centering system of claim 7, wherein said diffusor plate positions in proximity to said reflector.

9. The single radar strip centering system of claim 1, wherein said radar emits the beams in the form of frequency-modulated, continuous-wave (FMCW) waveforms or range strobes and mixes the radar energy scattered off via the reciprocal path to form a signal.

10. The single radar strip centering system of claim 1, further comprises a control processor for processing the signal for measuring the position and width of said strip in order to adjust the position of said strip to meet or maintain centering.

11. The single radar strip centering system of claim 1, wherein said radar and said reflector are positioned on a common axis, such that said strip positions intentionally to occlude one-half of the illuminating radar beam.

12. A method of providing a single radar strip centering system for measuring the position and width of a continuous metal strip during processing to facilitate adjustment of the strip's position for centering, said method comprising the steps of:
providing a radar emitting beams;
providing a reflector positioned apart and facing said radar;
providing a continuous metal strip positioned between said radar and said reflector, said strip comprising a leading edge and a trailing edge, said leading edge indicating an edge closer to said radar, said trailing edge indicating an edge away from said radar;
simultaneously illuminating said leading edge of the strip and said reflector by said radar such that said reflector augments and shapes scattered energy; and
redirecting by said reflector the transmitted radar energy toward said trailing edge and reflecting radar energy scattered off said trailing edge back toward said radar via a reciprocal path.

13. The method of claim 12, further comprising providing said reflector having a spherical surface.

14. The method of claim 12, further comprising implementing said single radar strip centering system in a furnace having a near wall and a far wall, said near wall indicating a wall on the side of said radar, said far wall indicating a wall on the side of said reflector.

15. The method of claim 14, further comprising providing a planar surface at said far wall for impinging the radar energy at near normal incidence.

16. The method of claim 14, further comprising aligning said radar and said reflector such that an antenna boresight vector of said radar is coincident with, and anti-parallel to, the axis of symmetry of the surface of said reflector.

17. The method of claim 16, further comprising positioning said reflector such that a center point of the surface of said reflector is at the same distance from the antenna boresight vector as said far wall.

18. The method of claim 12, further comprising providing a diffusor plate for redirecting the returning radar energy scattered off from said reflector and supporting detection of the radar energy at said trailing edge.

19. The method of claim 18, further comprising positioning said diffusor plate in proximity to said reflector.

20. The method of claim 12, further comprising providing a control processor for processing a signal formed in response to said radar emitting the beams in the form of frequency-modulated, continuous-wave (FMCW) waveforms or range strobes and mixing the radar energy scattered off via the reciprocal path.
